(19) United States
(12) Patent Application Publication
(10) Pub. No.: US 2008/0165739 A1
(43) Pub. Date: Jul. 10, 2008

(54) NETWORK DEVICES HAVING HANDOVER INFORMATION AND METHOD OF EXCHANGING HANDOVER INFORMATION BETWEEN THE DEVICES

(75) Inventor: SOO-HONG PARK, Gwangju-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/968,282

(22) Filed: Jan. 2, 2008

Related U.S. Application Data
(60) Provisional application No. 60/878,683, filed on Jan. 5, 2007.

(30) Foreign Application Priority Data
May 4, 2007 (KR) 2007-43793

(51) Int. Cl. H04Q 7/20

(52) U.S. Cl. 370/331

(57) ABSTRACT

An apparatus and method of providing, and an apparatus and method of requesting, current handover information between network devices, the method of providing the current handover information for a handover of a mobile terminal between networks including: detecting handover information regarding an environment of a network of a handover information providing apparatus if the environment of the network changes, and transmitting a message including the handover information regarding the changed environment from the handover information providing apparatus to a handover information storage apparatus. Accordingly, since the handover information storage apparatus maintains the current handover information and provides the current handover information to the mobile terminal, the mobile terminal performs the most correct determination when performing a handover. Furthermore, since the current state of the handover information providing apparatus is detected, the handover information storage apparatus provides additional information needed for the mobile terminal to effectively perform handover.

### CROSS-REFERENCE TO RELATED APPLICATIONS

This application claims the benefit of Korean Application No. 2007-43793, filed on May 4, 2007 in the Korean Intellectual Property Office, and the benefit of U.S. Provisional Patent Application No. 60/878,683 filed on Jan. 5, 2007 in the U.S. Patent and Trademark Office, the disclosures of which are incorporated herein by reference.

### BACKGROUND OF THE INVENTION

1. Field of the Invention

Aspects of the present invention relate to a communication system, and more particularly, to technology for information exchange between network devices having handover information.

2. Description of the Related Art

Various types of wireless technology have recently become widespread. Handover information is information used by a mobile terminal to perform a handover when moving between networks using different wireless technologies. The IEEE 802.21 Media Independent Handover (MIH) Work Group standardizes technology for receiving handover information from a network before moving between networks using the handover information.

Generally, the handover information is stored in a handover information storage apparatus. However, the IEEE 802.21 standard does not define how to manage information stored in a handover information storage apparatus.

Information on wireless coverage varies over time and/or between networks. For example, the bandwidth provided by a network and the state of wireless coverage vary over time. However, no method exists to maintain current state handover information in a handover information storage apparatus. Thus, no method exists for a mobile terminal to determine whether handover information received from a handover information storage apparatus is current.

Handover information that a mobile terminal receives when moving between networks must be current, reflecting the varying network state. Thus, technology to exchange current handover information between network devices having handover information is required.

### SUMMARY OF THE INVENTION

Aspects of the present invention provide a method of providing handover information to a handover information storage apparatus for a handover of a mobile terminal between networks, and a computer readable recording medium storing a computer readable program for executing the method.

Aspects of the present invention also provide a method of receiving and storing handover information from a handover information providing apparatus for a handover of a mobile terminal between networks, and a computer readable recording medium storing a computer readable program for executing the method.

Aspects of the present invention also provide a handover information providing apparatus to provide handover information to a handover information storage apparatus for a handover of a mobile terminal between networks, and a handover information storage apparatus to receive and to store the handover information from a handover information providing apparatus for the handover of the mobile terminal.

Aspects of the present invention also provide an information storage medium in which a data format of a message for exchanging handover information between a handover information providing apparatus and a handover information storage apparatus is recorded.

According to an aspect of the present invention, there is provided a method of providing handover information to a handover information storage apparatus for a handover of a mobile terminal between networks, the method including: detecting handover information regarding an environment of a network of a handover information providing apparatus if the environment of the network changes; and transmitting a message including the handover information regarding the changed environment from the handover information providing apparatus to the handover information storage apparatus.

The message including the handover information may use a protocol of a layer above an Internet Protocol (IP) layer, or a Media Independent Handover (MIH) protocol.

The handover information providing apparatus may be an Access Point (AP) and/or a Base Station (BS).

The handover information may contain a bandwidth of the network of the handover information providing apparatus, and/or a bit rate receivable in the network.

According to another aspect of the present invention, there is provided a method of receiving and storing handover information from a handover information providing apparatus for a handover of a mobile terminal between networks, the method including: transmitting a message requesting current handover information from the handover information providing apparatus if previous handover information has been stored in a handover information storage apparatus for a predetermined period of time or longer; receiving a message including the current handover information from the handover information providing apparatus; and extracting the current handover information from the message including the current handover information and storing the current handover information in the handover information storage apparatus.

The message requesting the current handover information and the message including the current handover information may use a protocol of a layer above an Internet Protocol (IP) layer, or a Media Independent Handover (MIH) protocol.

The handover information storage apparatus may be an Information Server (IS).

The handover information may contain a bandwidth of a network of the handover information providing apparatus, or a bit rate receivable in the network.

According to another aspect of the present invention, there is provided a handover information providing apparatus to provide handover information to a handover information storage apparatus for a handover of a mobile terminal between networks, the handover information providing apparatus including: a handover information detector to detect handover information regarding an environment of a network of the handover information providing apparatus if the environment of the network changes; and a handover information transmitter to transmit a message including the handover information regarding the changed environment to the handover information storage apparatus.

The handover information providing apparatus may further include: a message receiver to receive a message requesting current handover information from the handover information storage apparatus, wherein the handover information detector detects the current handover information, and the handover information transmitter transmits a message including the current handover information to the handover information storage apparatus when the message receiver receives the message requesting the current handover information.

The handover information transmitter may transmit the message using a protocol of a layer above an Internet Protocol (IP) layer, or a Media Independent Handover (MIH) protocol.

The handover information providing apparatus may be an Access Point (AP) and/or a Base Station (BS).

The handover information may contain a bandwidth of the network of the handover information providing apparatus, and/or the bit rate receivable in the network.

According to another aspect of the present invention, there is provided a handover information storage apparatus to receive and to store handover information from a handover information providing apparatus for a handover of a mobile terminal between networks, the handover information storage apparatus including: a handover information storage unit to store handover information; an information management unit to determine whether the handover information has been stored in the handover information storage unit for a predetermined period of time or longer; a message transmitter to transmit a message requesting current handover information from the handover information providing apparatus if the handover information has been stored in the handover information storage unit for the predetermined period of time or longer; a message receiver to receive a message including the current handover information from the handover information providing apparatus; and a handover information updating unit to update the handover information stored in the handover information storage unit by extracting the current handover information from the message including the current handover information.

The message receiver may receive a message including the current handover information from the handover information providing apparatus when an environment of a network of the handover information providing apparatus changes, and the handover information updating unit may extract the current handover information regarding the changed environment from the message transmitted from the handover information providing apparatus and store the extracted handover information in the handover information storage unit.

The message transmitter may transmit a message using a protocol of a layer above an Internet Protocol (IP) layer, or a Media Independent Handover (MIH) protocol.

The handover information storage apparatus may be an Information Server (IS).

The handover information may contain a bandwidth of the network of the handover information providing apparatus, and/or a bit rate receivable in the network.

According to another aspect of the present invention, there is provided an information storage medium in which a data format of a message executed by a handover information providing apparatus and/or a handover information storage apparatus for exchanging handover information between the handover information providing apparatus and the handover information storage apparatus is recorded, the message including: an Internet Protocol (IP) header; a Transport Control Protocol (TCP) or User Datagram Protocol (UDP) header; a handover information message exchange header to indicate a type of an exchange of the handover information to be performed by the handover information providing apparatus and/or the handover information storage apparatus; and a handover information field including the handover information.

The handover information message exchange header may include: a message type field to indicate the type of the exchange of the handover information to be performed by the handover information providing apparatus and/or the handover information storage apparatus; and a message length field to indicate a length of the message.

The message type field may have a value of “Reply” when the type of the exchange is a transmission of handover information regarding a changed environment if the environment of the network of the handover information providing apparatus changes.

The message type field may have a value of “Request” when the type of the exchange is a request for current handover information with respect to handover information that has been stored in the handover information storage apparatus for a predetermined period of time or longer, and the handover information field may include the handover information that has been stored for a predetermined period of time or longer.

According to another aspect of the present invention, there is provided an information storage medium in which a data format of a message for exchanging handover information between a handover information providing apparatus and a handover information storage apparatus is recorded, the message, which is a message for transmitting handover information regarding a changed environment using a Media Independent Handover (MIH) protocol if the environment of the network of the handover information providing apparatus changes or a message used by the handover information storage apparatus to request current handover information with respect to handover information that has been stored in the handover information storage apparatus for a predetermined period of time or longer, including: a field indicating a type of the message; a field indicating a length of the message; and a field including the handover information regarding the changed environment or the handover information that has been stored for the predetermined period of time or longer.

According to another aspect of the present invention, there is provided a system to maintain handover information for a handover of a mobile terminal between networks, the system including: a handover information providing apparatus to provide current handover information, the handover information providing apparatus including: a handover information detector to detect current handover information regarding an environment of a network of the handover information providing apparatus if the environment of the network changes, and a handover information transmitter to transmit a message comprising the current handover information regarding the changed environment; and a handover information storage apparatus to receive the current handover information, the handover information storage apparatus including: a handover information storage unit to store handover information, a message receiver to receive the message comprising the current handover information regarding the changed environment, and a handover information updating unit to update the handover information stored in the handover information storage unit by extracting the current handover information from the message comprising the current handover information.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a mobile communication environment in which handover information is exchanged according to an embodiment of the present invention;

FIG. 2 is a block diagram of a handover information providing apparatus according to an embodiment of the present invention;

FIG. 3 is a block diagram of a handover information storage apparatus according to an embodiment of the present invention;

FIG. 4 is a signaling diagram of a process of updating handover information according to an embodiment of the present invention;

FIG. 5 illustrates a message format using a protocol of a layer above an Internet Protocol (IP) layer, according to an embodiment of the present invention;

FIG. 6 illustrates a handover information message exchange header when a handover information storage apparatus requests handover information from a handover information providing apparatus according to an embodiment of the present invention;

FIG. 7 illustrates a handover information message exchange header when a handover information providing apparatus transmits handover information to a handover information storage apparatus according to an embodiment of the present invention; and

FIG. 8 illustrates a message format using an IEEE 802.21 Media Independent Handover (MIH) protocol, according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

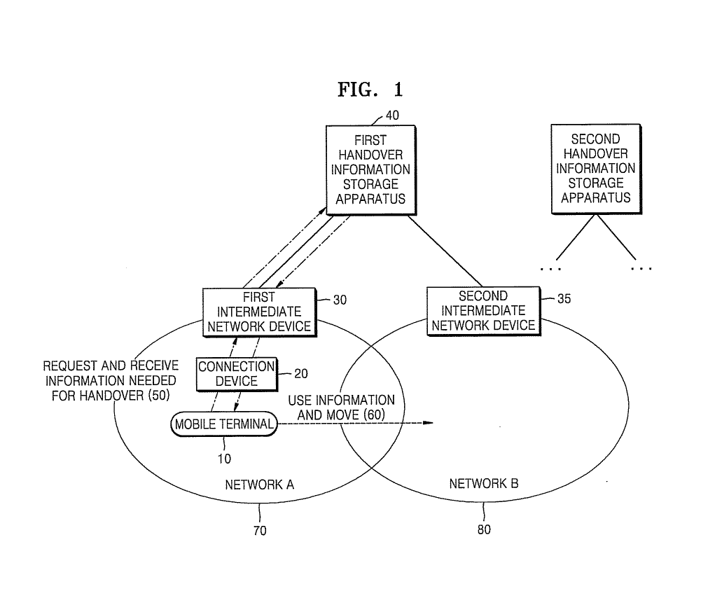

FIG. 1 illustrates a mobile communication environment in which handover information is exchanged according to an embodiment of the present invention. Referring to FIG. 1, the mobile communication environment includes a plurality of networks 70 and 80. Specifically, in FIG. 1, a network A 70 and a network B 80 are shown.

Each network includes an intermediate network device 30 and 35 that connects a mobile terminal 10 in a network coverage area corresponding to the intermediate network device 30 and 35 to another network device. The network A 70 includes a first intermediate network device 30, and the network B 80 includes a second intermediate network device 35. The intermediate network device 30 and 35 may be an Access Router (AR), although not limited thereto. That is, the intermediate network device 30 and 35 may be any device that connects a mobile terminal and another network device.

A connection device 20, which is a point of connection or a Point of Attachment (PoA), exists between the mobile terminal 10 and the first intermediate network device 30. Examples of the connection device 20 include an Access Point (AP) and a Base Station (BS), although not limited thereto. That is, any device that connects a mobile terminal 10 and an intermediate network device 30 may be a connection device 20. The connection device 20 is directly connected to the mobile terminal 10, and various wireless technologies are applied to the connection device 20. Thus, information on the connection device 20 (i.e., handover information) is required for the mobile terminal 10 to perform a handover. The handover information contains specifications of a wireless technology used by the connection device 20, the bandwidth of the network to which the connection device 20 belongs, and/or the bit rate receivable in the network. However, it is understood that the handover information is not limited thereto, and may include additional information.

A handover information storage apparatus 40 is connected to a network and stores handover information for the handover of the mobile terminal 10. When the mobile terminal 10 moves to another wireless environment, the mobile terminal requests handover information regarding the other wireless environment from the handover information storage apparatus 40, receives the requested handover information, and uses the requested handover information to perform the handover. An example of the handover information storage apparatus 40 is an Information Server (IS). However, it is understood that the handover information storage apparatus 40 is not limited to the IS.

Referring to FIG. 1, the mobile terminal 10 belongs to the coverage area of the network A 70. Accordingly, the mobile terminal 10 is connected to the first intermediate network device 30 via the connection device 20. The mobile terminal 10 is moving from the coverage area of the network A 70 to the coverage of the network B 80, and therefore requires handover information regarding the network B 80. Thus, the mobile terminal 10 requests the handover information required from a first handover information storage apparatus 40, and receives the handover information of the network B 80 from the first handover information storage apparatus 40 (as referred to by reference numeral 50). The mobile terminal 10 performs the handover using the handover information and moves to the coverage area of the network B 80 (as referred to by reference numeral 60). After moving to the coverage area of the network B 80, the mobile terminal 10 performs network communication with other networks via the second intermediate network device 35.

The connection device 20 may be located at the best position to detect the state of a wireless environment. Thus, the connection device 20 may detect changes to the handover information (such as the state of a wireless environment) and transmit information on the changes to the first handover information storage apparatus 40.

According to aspects of the present invention, a handover information providing apparatus detects and transmits current handover information to a handover information storage apparatus 40. The connection device 20 illustrated in FIG. 1 may be used as the handover information providing apparatus, or another device may be used as the handover information providing apparatus.

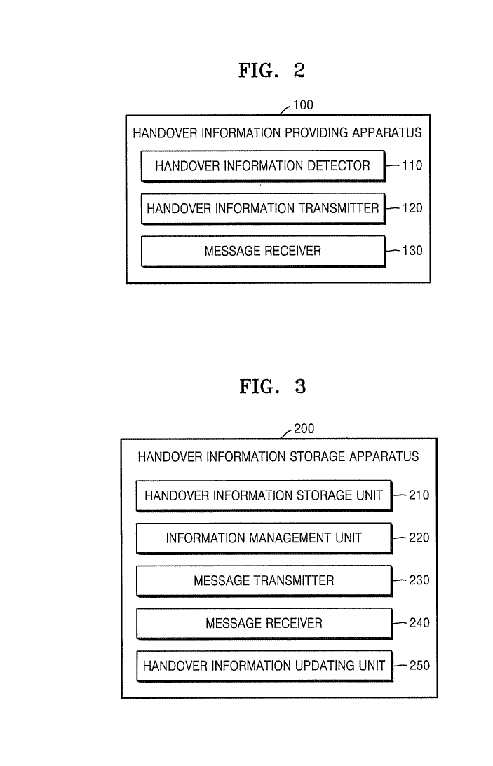

FIG. 2 is a block diagram of a handover information providing apparatus 100 according to an embodiment of the present invention. Referring to FIG. 2, if an environment changes in a network to which the handover information providing apparatus 100 belongs (i.e., the handover information changes), the handover information providing apparatus 100 detects handover information regarding the changed environment and provides the handover information to the handover information storage apparatus 40. The handover information providing apparatus 100 includes a handover information detector 110, a handover information transmitter 120, and a message receiver 130.

The handover information detector 110 detects handover information regarding the changed environment if the environment in the network changes. The handover information may include the bandwidth of the network to which the handover information detector 110 belongs, and/or the bit rate receivable in the network.

The handover information transmitter 120 transmits the handover information regarding the changed environment detected by the handover information detector 110 to the handover information storage apparatus 40.

The message receiver 130 receives a message requesting the current handover information from the handover information storage apparatus. The processing of a request for the current handover information, which is received from the handover information storage apparatus 40, will be described in detail later with reference to FIG. 3. It is understood that, according to other aspects, the handover information providing apparatus does not include the message receiver 130. For example, the handover information providing apparatus 100 may automatically transmit changed handover information to the handover information storage apparatus 40 whenever the handover information is changed or whenever the handover information providing apparatus 100 determines that the handover information storage apparatus 40 does not store a most current handover information.

When the message receiver 130 receives a message requesting the current handover information from the handover information storage apparatus 40, the handover information detector 110 further detects handover information. Then, the handover information transmitter 120 transmits a message containing the detected handover information to the handover information storage apparatus.

FIG. 3 is a block diagram of a handover information storage apparatus 200 according to an embodiment of the present invention. Referring to FIG. 3, the handover information storage apparatus 200 stores and manages handover information. The handover information storage apparatus 200 transmits handover information to the mobile terminal 10 if a request for the handover information is received. However, it is understood that according to other aspects of the present invention, the handover information storage apparatus 200 may transmit the handover information to the mobile terminal 10 automatically. An example of the handover information storage apparatus 200 is an information server (IS).

The handover information storage apparatus 200 includes a handover information storage unit 210, an information management unit 220, a message transmitter 230, a message receiver 240, and a handover information updating unit 250.

The handover information storage unit 210 stores handover information for a mobile terminal 10 to perform a handover.

The information management unit 220 determines whether any handover information stored in the handover information storage unit 210 has been stored for a predetermined period of time or longer. In the current embodiment, the information management unit 220 has a timer function. However, it is understood that, according to other aspects, the handover information storage apparatus 200 does not include the information management unit 220 and does not have a timer function.

The message transmitter 230 transmits a message requesting the current handover information to the handover information providing apparatus 100. The message requesting current handover information is transmitted by the message transmitter 230 and received by the message receiver 130 of the handover information providing apparatus 100. If the handover information detector 110 detects handover information requested by the message requesting current handover information, the handover information transmitter 120 transmits a message containing the detected handover information to the handover information storage apparatus 200. It is understood that, according to other aspects, the handover information storage apparatus 200 does not include the message transmitter and/or the handover information providing apparatus 100 automatically transmits the current handover information.

The message receiver 240 of the handover information storage apparatus 200 receives the message containing the current handover information, which is transmitted from the handover information providing apparatus 100.

The handover information updating unit 250 updates the handover information stored in the handover information storage unit 210 by extracting the current handover information from the message containing the current handover information.

As described with reference to FIG. 2, if an environment changes in the network to which the handover information providing apparatus 100 belongs, the handover information providing apparatus 100 transmits a message containing handover information regarding the changed environment to the handover information storage apparatus 200. In this case, the message receiver 240 of the handover information storage apparatus 200 receives the message transmitted from the handover information providing apparatus 100. Then, the handover information updating unit 250 extracts the current handover information from the received message and stores the extracted handover information in the handover information storage unit 210.

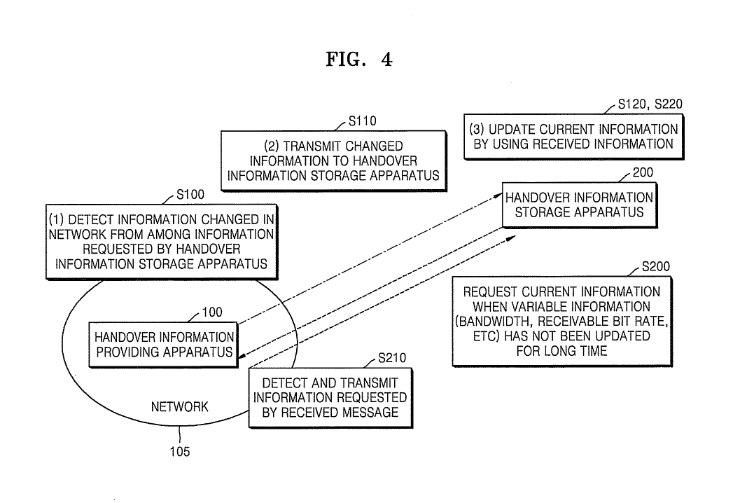

FIG. 4 is a signaling diagram of a process of updating handover information according to an embodiment of the present invention. For convenience of description, only the handover information providing apparatus 100, the handover information storage apparatus 200, and a network 105 to which the handover information providing apparatus 100 belongs are shown in FIG. 4.

A case where an environment of the network 105 to which the handover information providing apparatus 100 belongs changes will now be described. Referring to FIG. 4, the handover information providing apparatus 100 detects changed handover information in the network 105 in operation S100. The handover information providing apparatus 100 transmits the changed handover information to the handover information storage apparatus 200 in operation S110. The handover information storage apparatus 200 updates the current handover information using the received handover information in operation S120.

A case where the handover information storage apparatus 200 requests the current handover information from the handover information providing apparatus 100 by performing the timer function will now be described. First, the handover information storage apparatus 200 performs the timer function to determine whether the handover information corresponding to the network 105 and stored in the handover information storage unit 210 has not been updated for a predetermined period of time. If it is determined that the handover information has not been updated for a predetermined period of time, the handover information storage apparatus 200 requests the current handover information from the handover information providing apparatus 100 in operation S200. The handover information providing apparatus 100 detects handover information requested by a received message and transmits the detected handover information to the handover information storage apparatus 200 in operation S210. The handover information storage apparatus 200 updates the current handover information using the received handover information in operation S220.

As described above, the handover information storage apparatus 200 maintains the current handover information by receiving handover information regarding a changed environment from the handover information providing apparatus 100, if the environment of the network 105 to which the handover information providing apparatus 100 belongs changes. Alternatively (or additionally), the handover information storage apparatus 200 maintains the current handover information by requesting and receiving the current handover information if the handover information providing apparatus 100 has not transmitted new handover information for a predetermined period of time. Thus, the handover information storage apparatus 200 can provide the current handover information to the mobile terminal 10, and the mobile terminal 10 can therefore perform the most correct determination when performing a handover.

Since the handover information storage apparatus 200 requests the current handover information from the handover information providing apparatus 100 to update handover information that has not been updated for a predetermined period of time, when the handover information storage apparatus 200 manages the handover information, the current state of the handover information providing apparatus 100 can be detected. This is effective, for example, when the handover information providing apparatus 100 is a PoA. In this case, if handover information has not been updated for a predetermined period of time, the handover information storage apparatus 200 requests and receives the current handover information from a PoA corresponding to the handover information. Thus, when a problem occurs in the PoA, the handover information storage apparatus 200 can detect the problem, and the handover information storage apparatus 200 does not provide the handover information to the mobile terminal 10. Alternatively, the handover information storage apparatus 200 provides both the handover information and information indicating that a problem has occurred in the PoA. In this case, the mobile terminal 10 can perform the best selection in the handover (e.g., can prevent a handover to the network to which the PoA belongs). Thus, the handover information storage apparatus 200 may provide additional information needed for the mobile terminal 10 to effectively perform a handover.

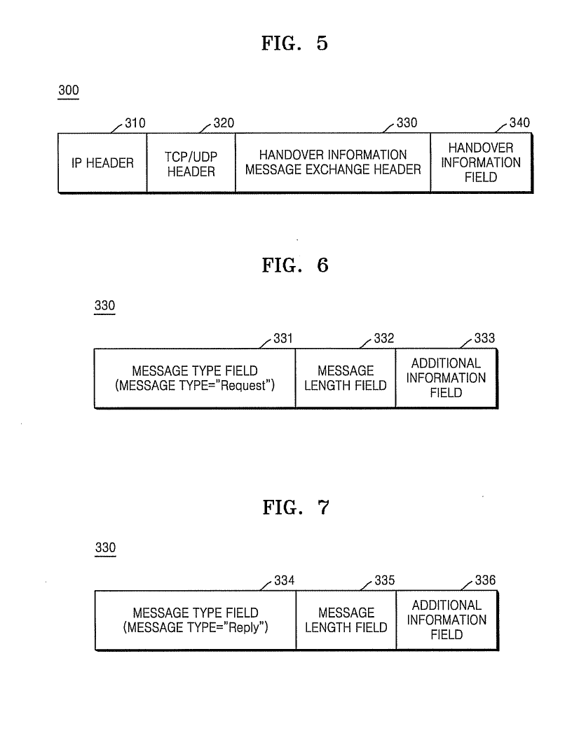

A message for exchanging information between the handover information providing apparatus 100 and the handover information storage apparatus 200 may newly define and use a protocol of a layer above an Internet Protocol (IP) layer, or extend and use a Media Independent Handover (MIH) protocol. This will now be described in more detail with reference to FIGS. 5 through 8.

FIG. 5 illustrates a message format using a protocol of a layer above an IP layer, according to an embodiment of the present invention. Referring to FIG. 5, a message 300 for exchanging information according to aspects of the present invention includes an IP header 310, a Transport Control Protocol (TCP) or User Datagram Protocol (UDP) header 320, a handover information message exchange header 330, and a handover information field 340. Thus, the handover information message exchange header 330 is additionally defined after the IP header 310 and the TCP/UDP header 320.

The handover information field 340 includes the current handover information detected by the handover information providing apparatus 100 or handover information requested by the handover information storage apparatus 200 for updating.

FIGS. 6 and 7 are more detailed illustrations of the handover information message exchange header 330. FIG. 6 illustrates the handover information message exchange header 330 when the handover information storage apparatus 200 requests handover information from the handover information providing apparatus 100 according to an embodiment of the present invention. If the handover information storage apparatus 200 detects that handover information has been stored for a predetermined period of time or longer (by using, for example, a timer function), the handover information storage apparatus 200 requests the current handover information from the handover information providing apparatus 100 with respect to the detected handover information.

In this case, the handover information message exchange header 330 includes a message type field 331, a message length field 332, and an additional information field 333. Alternatively, it is understood that the additional information field 333 may not be included.

The message type field 331 has a value of “Request.” In this case, the handover information field 340 contains the handover information that has been stored for a predetermined period of time or longer and needs to be updated.

FIG. 7 illustrates the handover information message exchange header 330 when the handover information providing apparatus 100 transmits handover information to the handover information storage apparatus 200 according to an embodiment of the present invention. If the environment of a network to which the handover information providing apparatus 100 belongs changes, the handover information providing apparatus 100 transmits handover information regarding the changed environment to the handover information storage apparatus 200.

In this case, the handover information message exchange header 330 includes a message type field 334, a message length field 335, and an additional information field 336. Alternatively, it is understood that the additional information field 336 may not be included.

The message type field 334 has a value of “Reply.” In this case, the handover information field 340 contains the current handover information regarding the changed environment.

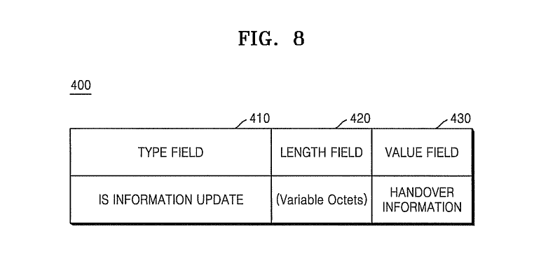

FIG. 8 illustrates a message format using an IEEE 802.21 MIH protocol, according to an embodiment of the present invention. Referring to FIG. 8, a message 400 according to an embodiment of the present invention has a TLV format. The TLV format indicates that the message 400 includes a Type field 410 indicating the message type, a Length field 420 indicating the message length, and a Value field 430 indicating the message value.

In the message 400, the Type field 410 has a value of “IS Information Update,” (or any message indicating a handover information update), the Length field 420 indicates a variable octet length, and the Value field 430 contains handover information.

If the handover information providing apparatus 100 transmits a message to the handover information storage apparatus 200 when the environment of the network to which the handover information providing apparatus 100 belongs changes, the Value field 430 contains handover information regarding the changed environment.

If the handover information storage apparatus 200 requests the current handover information from the handover information providing apparatus 100 with respect to outdated handover information, the Value field 430 contains the outdated handover information to be updated.

Aspects of the present invention can also be embodied as computer (including all devices having an information processing function) readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and a computer data signal embodied in a carrier wave comprising a compression source code segment comprising the code and an encryption source code segment comprising the code (such as data transmission through the Internet). The computer-readable recording medium can also be distributed over network-coupled computer systems so that the computer-readable code is stored and executed in a distributed fashion. Aspects of the present invention may also be realized as a data signal embodied in a carrier wave and comprising a program readable by a computer and transmittable over the Internet.

As described above, according to aspects of the present invention, a handover information storage apparatus can maintain the current handover information by receiving handover information regarding a changed environment, from a handover information providing apparatus, if the environment of a network to which the handover information providing apparatus belongs changes. Alternatively (or additionally), the handover information storage apparatus can request and receive current handover information if the handover information providing apparatus has not transmitted the current handover information for a predetermined period of time. Thus, the handover information storage apparatus can provide the current handover information to a mobile terminal, and the mobile terminal can therefore perform the most correct determination when performing a handover. In addition, when the handover information storage apparatus manages handover information, the current state of the handover information providing apparatus, which corresponds to handover information which has not been updated for a long time, can be detected. Thus, when a problem occurs in the handover information providing apparatus (such as a PoA), the handover information storage apparatus does not provide corresponding handover information to a mobile terminal, or does provide both the handover information and information indicating that a problem has occurred in the PoA. In this case, the mobile terminal can perform the best selection in the handover (e.g., can prevent a handover to the network to which the PoA belongs). Thus, the handover information storage apparatus can provide additional information needed for the mobile terminal to effectively perform a handover.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of providing handover information to a handover information storage apparatus for a handover of a mobile terminal between networks, the method comprising:
detecting handover information regarding an environment of a network of a handover information providing apparatus if the environment of the network changes; and
transmitting a message comprising the handover information regarding the changed environment from the handover information providing apparatus to the handover information storage apparatus.

2. The method as claimed in claim 1, wherein the message comprising the handover information uses a protocol of a layer above an Internet Protocol (IP) layer.

3. The method as claimed in claim 1, wherein the message comprising the handover information uses a Media Independent Handover (MIH) protocol.

4. The method as claimed in claim 1, wherein the handover information providing apparatus is an Access Point (AP) and/or a Base Station (BS).

5. The method as claimed in claim 1, wherein the handover information comprises a bandwidth of the network of the handover information providing apparatus and/or a bit rate receivable in the network.

6. A method of receiving and storing handover information from a handover information providing apparatus for a handover of a mobile terminal between networks, the method comprising:
transmitting a message requesting current handover information from the handover information providing apparatus if previous handover information has been stored in a handover information storage apparatus for a predetermined period of time or longer;
receiving a message comprising the current handover information from the handover information providing apparatus; and
extracting the current handover information from the message comprising the current handover information and storing the current handover information in the handover information storage apparatus.

7. The method as claimed in claim 6, wherein the message requesting the current handover information and/or the message comprising the current handover information use a protocol of a layer above an Internet Protocol (IP) layer.

8. The method as claimed in claim 6, wherein the message requesting the current handover information and/or the message comprising the current handover information use a Media Independent Handover (MIH) protocol.

9. The method as claimed in claim 6, wherein the handover information storage apparatus is an Information Server (IS).

10. The method as claimed in claim 6, wherein the handover information comprises a bandwidth of a network of the handover information providing apparatus and/or a bit rate receivable in the network.

11. The method as claimed in claim 6, wherein the handover information providing apparatus is an Access Point (AP) and/or a Base Station (BS).

12. The method as claimed in claim 6, further comprising:
detecting a state of the handover information providing apparatus from the received message;
determining whether a problem exists in the handover information providing apparatus based on the state of the handover information providing apparatus; and
preventing a handover of the mobile terminal to a network of the handover information providing apparatus if the problem exists in the handover information providing apparatus.

13. The method as claimed in claim 6, further comprising:
detecting a state of the handover information providing apparatus from the received message;
determining whether a problem exists in the handover information providing apparatus based on the state of the handover information providing apparatus; and
transmitting information to the mobile terminal indicating that the problem exists in the handover information providing apparatus if the problem exists in the handover information providing apparatus.

14. An information storage medium in which a data format of a message executed by a handover information providing apparatus and/or a handover information storage apparatus for exchanging handover information between the handover information providing apparatus and the handover information storage apparatus is recorded, the message comprising:
an Internet Protocol (IP) header;
a Transport Control Protocol (TCP) or User Datagram Protocol (UDP) header;
a handover information message exchange header to indicate a type of an exchange of the handover information to be performed by the handover information providing apparatus and/or the handover information storage apparatus; and
a handover information field including the handover information.

15. The information storage medium as claimed in claim 14, wherein the handover information message exchange header comprises:
a message type field to indicate the type of the exchange of the handover information to be performed by the handover information providing apparatus and/or the handover information storage apparatus; and
a message length field to indicate a length of the message.

16. The information storage medium as claimed in claim 15, wherein the message type field has a first value when the type of the exchange is a transmission of handover information regarding a changed environment if an environment of a network of the handover information providing apparatus changes.

17. The information storage medium as claimed in claim 15, wherein the message type field has a second value when the type of the exchange is a request for current handover information with respect to handover information that has been stored in the handover information storage apparatus for a predetermined period of time or longer, and
the handover information field includes the handover information that has been stored for the predetermined period of time or longer.

18. An information storage medium in which a data format of a message executed by a handover information providing apparatus and/or a handover information storage apparatus for exchanging handover information between the handover information providing apparatus and the handover information storage apparatus is recorded, the message comprising:
a field indicating a type of an exchange of the handover information, wherein the type of the exchange is a transmission of handover information regarding a changed environment using a Media Independent Handover (MIH) protocol if an environment of a network of the handover information providing apparatus changes, or a request for current handover information with respect to handover information that has been stored in the handover information storage apparatus for a predetermined period of time or longer;
a field indicating a length of the message; and
a field including the handover information regarding the changed environment or the handover information that has been stored for the predetermined period of time or longer.

19. A system to maintain handover information for a handover of a mobile terminal between networks, the system comprising:
a handover information providing apparatus to provide current handover information, the handover information providing apparatus comprising:
a handover information detector to detect current handover information regarding an environment of a network of the handover information providing apparatus if the environment of the network changes, and
a handover information transmitter to transmit a message comprising the current handover information regarding the changed environment; and
a handover information storage apparatus to receive the current handover information, the handover information storage apparatus comprising:
a handover information storage unit to store handover information,
a message receiver to receive the message comprising the current handover information regarding the changed environment, and
a handover information updating unit to update the handover information stored in the handover information storage unit by extracting the current handover information from the message comprising the current handover information.

20. The system as claimed in claim 19, wherein:
the handover information storage apparatus further comprises:
an information management unit to determine whether the handover information has been stored in the handover information storage unit for a predetermined period of time or longer, and
a message transmitter to transmit a message requesting the current handover information from the handover information providing apparatus if the handover information has been stored in the handover information storage unit for the predetermined period of time or longer; and
the handover information providing apparatus further comprises:
a message receiver to receive the message requesting the current handover information,
wherein the handover information detector detects the current handover information when the message receiver receives the message requesting the current handover information.

21. The system as claimed in claim 19, wherein the handover information transmitter transmits the message using a protocol of a layer above an Internet Protocol (IP) layer, or a Media Independent Handover (MIH) protocol.

22. The system as claimed in claim 19, wherein the handover information providing apparatus is an Access Point (AP) and/or a Base Station (BS).

23. The system as claimed in claim 19, wherein the handover information comprises a bandwidth of the network of the handover information providing apparatus, and/or a bit rate receivable in the network.

24. The system as claimed in claim 20, wherein the message transmitter transmits the message requesting the current handover information using a protocol of a layer above an Internet Protocol (IP) layer, or a Media Independent Handover (MIH) protocol.

25. The system as claimed in claim 19, wherein the handover information storage apparatus is an Information Server (IS).
